(19) United States
(12) Patent Application Publication
(10) Pub. No.: US 2023/0334869 A1
(43) Pub. Date: Oct. 19, 2023

(54) TURNING DIRECTION PREDICTION SYSTEM, MOVING SYSTEM, TURNING DIRECTION PREDICTION METHOD, AND PROGRAM

(71) Applicant: TOYOTA JIDOSHA KABUSHIKI KAISHA, Toyota-shi (JP)

(72) Inventor: Eisuke Aoki, Toyota-shi (JP)

(73) Assignee: TOYOTA JIDOSHA KABUSHIKI KAISHA, Toyota-shi (JP)

(21) Appl. No.: 18/131,941

(22) Filed: Apr. 7, 2023

(30) Foreign Application Priority Data
Apr. 13, 2022 (JP) 2022-066223

(51) Int. Cl. G06V 20/58; B60W 30/095

(52) U.S. Cl. CPC G06V 20/58; B60W 30/095; B60W 2420/42; B60W 2554/4029

(57) ABSTRACT

To predict a direction in which a person will turn more accurately. A turning direction prediction system includes a processor having a leg state detection unit configured to detect whether each of left and right legs of a person is in a swing state or a stance state, a chest rotation detection unit configured to detect information about a rotation of a chest of the person around a pitch axis, a yaw axis, and a roll axis, and a direction prediction unit configured to predict a direction in which the person will turn based on the states of the left and right legs detected by the leg state detection unit and the information about the rotation of the chest detected by the chest rotation detection unit.

### CROSS REFERENCE TO RELATED APPLICATIONS

This application is based upon and claims the benefit of priority from Japanese patent application No.2022-066223, filed on Apr. 13, 2022, the disclosure of which is incorporated herein in its entirety by reference.

### BACKGROUND

The present disclosure relates to a turning direction prediction system, a moving system, a turning direction prediction method, and a program for predicting a direction in which a person will turn.

A system in which a template that matches a pose taken by a person is found, and it is inferred that the pose is an intended pose that is associated with the template in advance has been known (see, for example, Published Japanese Translation of PCT International Publication for Patent Application, No. 2021-507434).

### SUMMARY

However, in the above-described system, it is not necessarily certain that the pose taken by the person is an intended pose associated with the template in advance, and there is thus a possibility that the direction in which the person will turn cannot be accurately predicted.

The present disclosure has been made in view of the above-described problem, and an object thereof is to provide a turning direction prediction system, a moving system, a turning direction prediction method, and a program capable of predicting a direction in which a person will turn more accurately.

To achieve the above-described object, a first exemplary aspect is a turning direction prediction system including a processor having:
a leg state detection unit configured to detect whether each of left and right legs of a person is in a swing state or a stance state;
a chest rotation detection unit configured to detect information about a rotation of a chest of the person around a pitch axis, a yaw axis, and a roll axis; and
a direction prediction unit configured to predict a direction in which the person will turn based on the states of the left and right legs detected by the leg state detection unit and the information about the rotation of the chest detected by the chest rotation detection unit.

In this aspect, the direction prediction unit may predict the person will turn to a swing-leg direction when it has determined that a spinal column of the person is in an extended state and the chest has rotated and side-flexed in a direction opposite to a traveling direction based on the information about the rotation of the chest around the pitch axis, the yaw axis, and the roll axis detected by the chest rotation detection unit, and

the direction prediction unit may predict the direction in which the person will turn based on a result of the prediction that the person will turn to the swing-leg direction and the states of the left and right legs of the person detected by the leg state detection unit.

In this aspect, the direction prediction unit may predict the person will turn to a stance-leg direction when it has determined that a spinal column of the person is in a flexed state and the chest has rotated and side-flexed in the same direction as the traveling direction based on the information about the rotation of the chest around the pitch axis, the yaw axis, and the roll axis detected by the chest rotation detection unit, and

the direction prediction unit may predict the direction in which the person will turn based on a result of the prediction that the person will turn to the stance-leg direction and the states of the left and right legs of the person detected by the leg state detection unit.

In this aspect, the processor of the turning direction prediction system may further include a neck direction detection unit configured to detect a direction of a rotation of a neck of the person around the yaw axis.

Further, the direction prediction unit may predict a tentative direction in which the person will turn based on the states of the left and right legs detected by the leg state detection unit and the information about the rotation of the chest detected by the chest rotation detection unit, and

the direction prediction unit may predict the predicted tentative direction as the direction in which the person will turn when it has determined that the predicted tentative direction coincides with the direction of the rotation of the neck around the yaw axis detected by the neck direction detection unit.

In this aspect, the processor of the turning direction prediction system may further include an eye direction detection unit configured to detect an eye direction of the person.

Further, the direction prediction unit may predict a tentative direction in which the person will turn based on the states of the left and right legs detected by the leg state detection unit and the information about the rotation of the chest detected by the chest rotation detection unit, and

the direction prediction unit may predict the predicted tentative direction as the direction in which the person will turn when it has determined that the predicted tentative direction coincides with the eye direction detected by the eye direction detection unit.

In this aspect, the direction prediction unit may predict the direction in which the person will turn based on the states of the left and right legs detected by the leg state detection unit, the information about the rotation of the chest detected by the chest rotation detection unit, the direction of the rotation of the neck detected by the neck direction detection unit, and the eye direction detected by the eye direction detection unit.

In this aspect, the direction prediction unit may predict a tentative direction in which the person will turn based on the states of the left and right legs detected by the leg state detection unit and the information about the rotation of the chest detected by the chest rotation detection unit, and

the direction prediction m unit eans may predict the tentative direction as the direction in which the person will turn when it has determined that all the eye direction, the direction of the rotation of the neck around the yaw axis, and the direction of the rotation of the chest around the yaw axis have successively pointed to the same direction in this order.

To achieve the above-described object, another exemplary aspect may be a moving system including:
the above-described turning direction prediction system; and
a warning unit configured to warn the person based on the direction in which the person will turn predicted by the direction prediction unit.

To achieve the above-described object, another exemplary aspect may be a moving system including:
the above-described turning direction prediction system; and
a control unit configured to control, based on the direction in which the person will turn predicted by the direction prediction unit, a vehicle so that the vehicle evades the person.

To achieve the above-described object, another exemplary aspect may be a turning direction prediction method including:
detecting whether each of left and right legs of a person is in a swing state or a stance state;
detecting information about a rotation of a chest of the person around a pitch axis, a yaw axis, and a roll axis; and
predicting a direction in which the person will turn based on the detected states of the left and right legs and the detected information about the rotation of the chest.

To achieve the above-described object, another exemplary aspect may be a program for causing a computer to perform:
a process for detecting whether each of left and right legs of a person is in a swing state or a stance state;
a process for detecting information about a rotation of a chest of the person around a pitch axis, a yaw axis, and a roll axis; and
a process for predicting a direction in which the person will turn based on the detected states of the left and right legs and the detected information about the rotation of the chest.

According to the present disclosure, it is possible to provide a turning direction prediction system, a moving system, a turning direction prediction method, and a program capable of predicting a direction in which a person will turn more accurately.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing a rough system configuration of a turning direction prediction system according to an embodiment;

FIG. 2 shows a direction of the chest of a person around a pitch axis, a yaw axis, and a roll axis;

FIG. 3 shows a spin turn and a step turn;

FIG. 4 is a flowchart showing a flow of a turning direction prediction method according to an embodiment;

FIG. 5 is a block diagram showing a rough system configuration of a turning direction prediction system according to an embodiment;

FIG. 6 is a flowchart showing a flow of a turning direction prediction method according to an embodiment;

FIG. 7 is a block diagram showing a rough system configuration of a turning direction prediction system according to an embodiment;

FIG. 8 is a block diagram showing a rough system configuration of a turning direction prediction system according to an embodiment;

FIG. 9 shows a rough system configuration of a moving system according to an embodiment; and

FIG. 10 shows a configuration in which a turning direction prediction system is provided outside a vehicle.

### DESCRIPTION OF EMBODIMENTS

The present disclosure will be described hereinafter through embodiments of the disclosure, but the present disclosure according to the claims is not limited to the below-shown embodiments.

### First Embodiment

There are cases where, for example, when a vehicle approaches a person from behind or when a person is walking/running alongside a vehicle, the person suddenly turns without looking behind him/her or looking to the side (e.g., to the right or left). In this case, the vehicle and the person could collide into each other.

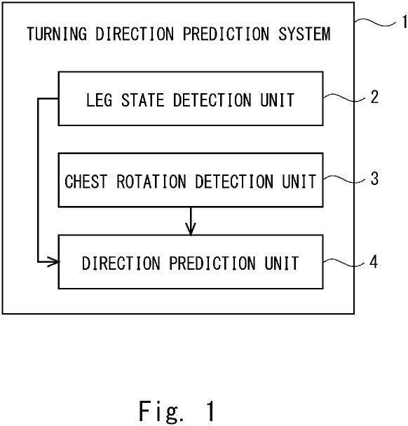

To cope with such a situation, a turning direction prediction system according to this embodiment can, as will be described in detail later, accurately and swiftly predict the direction in which the person will turn by accurately recognizing that he/she intends to make a turn by using human biomechanics. In this way, it is possible to reliably prevent, for example, a vehicle and a person from colliding into each other, which collision would otherwise occur as described above. FIG. 1 is a block diagram showing a rough system configuration of a turning direction prediction system according to this embodiment.

A turning direction prediction system 1 according to this embodiment includes a leg state detection unit 2 that detects whether each of the left and right legs of a person is in a swing state or a stance state, a chest rotation detection unit 3 that detects (i.e., acquires) information about the rotation of the chest of the person around a pitch axis, a yaw axis, and a roll axis, and a direction prediction unit 4 that predicts a direction in which the person will turn.

The leg state detection unit 2 is a specific example of a leg state detection means. For example, the leg state detection unit 2 detects whether each of the left and right legs of a person is in a swing state or a stance state based on, for example, an image(s) of the person acquired by a 3D (three-dimensional) camera.

Note that the stance state is a state in which the person, during his/her walking, stands on the ground on the sole(s) of his/her foot(feet) and thereby supports his/her body. The swing state is a state in which the person, during his/her walking, lifts his or her foot and swings the lifted foot forward or backward. When a person is walking, each of the left and right legs alternately repeats the stance state and the swing state.

The leg state detection unit 2 may, for example, learn images of the swing and stance states of the left and right legs of a person(s) by using a machine learning apparatus such as a neural network, and detect the above-described swing and stance states by using the result of the learning. The leg state detection unit 2 outputs the detected states of the left and right legs to the direction prediction unit 4.

The chest rotation detection unit 3 is a specific example of a chest rotation detection means. The chest rotation detection unit 3 detects (i.e., acquires) information about the rotation of the chest of the person around the pitch axis, the yaw axis, and the roll axis. The information about the rotation includes various information items such as the direction of the rotation, the angle of the rotation, and the amount of the rotation.

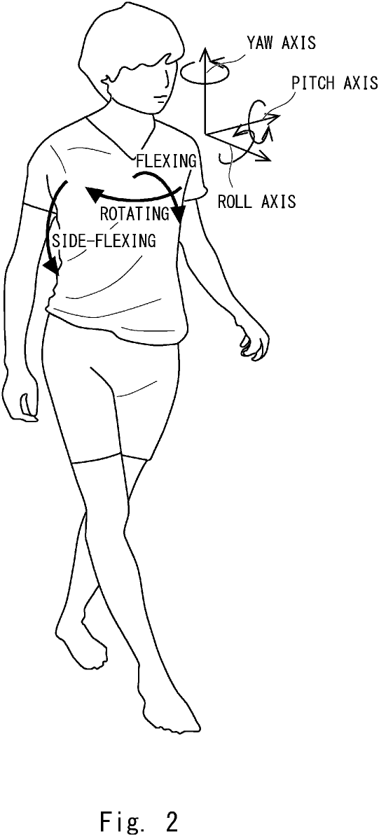

The chest rotation detection unit 3 generates, for example, a skeletal model of the person based on an image(s) of the person acquired by the 3D camera, and as shown in FIG. 2, detects (i.e., acquires) information about the rotation of the chest of the person around the pitch axis, the yaw axis, and the roll axis based on the generated skeletal model of the person.

The chest rotation detection unit 3 may learn images of the chest(s) of a person(s) by using a machine learning apparatus such as a neural network, and detect (i.e., acquire) information about the rotation of the chest of the person around the pitch axis, yaw axis, and roll axis by using the result of the learning. The chest rotation detection unit 3 outputs the information about the rotation of the chest of the person around the pitch axis, the yaw axis, and the roll axis to the direction prediction unit 4.

The direction prediction unit 4 is a specific example of a direction prediction means. The direction prediction unit 4 predicts a direction in which the person will turn based on the states of the left and right legs detected by the leg state detection unit 2 and the information about the rotation of the chest detected by the chest rotation detection unit 3. Specifically, the direction prediction unit 4 predicts whether the person will turn to the right or to the left.

Note that in the turning direction prediction system 1 according to this embodiment, attention is focused on the turning strategy when a person is walking and the kinematic chain when the person moves his/her body, and a method for determining a direction in which the person will turn is set accordingly. By using the above-described determination method, the turning direction prediction system 1 can accurately and swiftly predict the direction in which the person will turn. The method for determining a direction in which a person will turn will be described hereinafter in detail.

When attention is focused on the kinematic chain when a person moves, it is possible to infer his or her next movement based on his/her posture. For example, when a person will turn, pushing-out of the center of gravity, control of the direction of the center of gravity, control of the acceleration of the center of gravity, control of the balance of the trunk, and determination of the turning strategy are performed in this order.

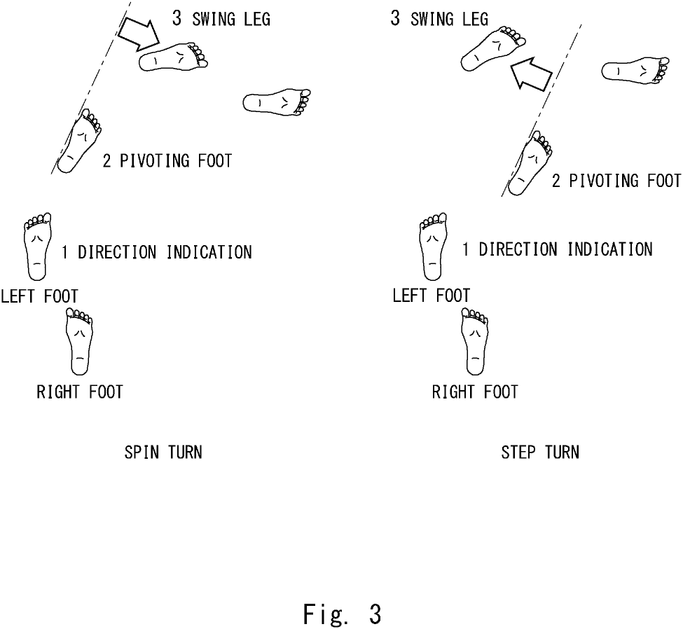

In the above-described determination of the turning strategy, for example, either a spin turn or a step turn is determined. The spin turn is, for example, a turning motion in which the person rotates his/her body like a top around the pivoting foot (the stance leg), and swings out the swing leg in the traveling direction (i.e., the walking direction) as shown on the left side in FIG. 3. In contrast, a step turn is, for example, a turning motion in which the person brings down the swing leg to the ground while keeping the pivoting foot on the ground, and then kicks out the swing leg from the ground and swings out the pivoting foot (the stance leg) in the traveling direction as shown on the right side in FIG. 3.

The control of the balance of the trunk for balancing the trunk is performed before the spin turn or the step turn is performed as described above. That is, this control of the balance of the trunk is a preliminary motion for performing the spin turn or the step turn. Therefore, by focusing attention on the above-described preliminary motion, it is possible to accurately predict whether the person will perform the spin turn or the step turn. Further, by predicting the spin turn or the step turn, it is possible to accurately predict the direction in which the person will turn as will be described later.

When a person performs a spin turn, as a preliminary motion for balancing the trunk, his/her spinal column becomes an extended state and his/her chest rotates in the direction opposite to the traveling direction. Further, his/her chest is side-flexed. In contrast, when a person performs a step turn, as a preliminary motion for balancing the trunk, his/her spinal column becomes a flexed state and his/her chest rotates in the same direction as the traveling direction. Further, his/her chest is side-flexed. Note that the above-described method for determining a turning direction is based on the assumption that the person is a healthy person, i.e., the assumption that elderly people whose balancing abilities are impaired are excluded.

The direction prediction unit 4 can detect that the spinal column of the person is in an extended state or is in a flexed state as described above based on the information about the rotation of the chest around the pitch axis detected by the chest rotation detection unit 3.

Based on the information about the rotation of the chest around the yaw axis detected by the chest rotation detection unit 3, the direction prediction unit 4 can detect that the chest has rotated in the same direction as the traveling direction or in the direction opposite to the traveling direction as described above.

The direction prediction unit 4 can detect that the chest has been side-flexed as described above based on the information about the rotation of the chest around the roll axis detected by the chest rotation detection unit 3.

The direction prediction unit 4 predicts the direction in which the person will turn based on the above-described method for determining the tuning direction as described below.

Based on the information about the rotation of the chest around the pitch axis, the yaw axis, and the roll axis detected by the chest rotation detection unit 3, the direction prediction unit 4 predicts that the person will perform a spin turn when it has determined that his/her spinal column is in an extended state and his/her chest has rotated and side-flexed in the direction opposite to the traveling direction, and thereby predicts that the person will turn to the swing-leg direction. Then, the direction prediction unit 4 predicts the direction in which the person will turn based on the result of the prediction that he/she will turn to the swing-leg direction and the states of the left and right legs of the person detected by the leg state detection unit 2.

For example, the leg state detection unit 2 detects that the right leg is in a swing state and the left leg is in a stance state. Further, the direction prediction unit 4 predicts that the person will turn to the swing-leg direction based on the information about the rotation of the chest around the pitch axis, the yaw axis, and the roll axis detected by the chest rotation detection unit 3. In this case, the direction prediction unit 4 predicts that the person will turn to the right based on the swing state of the right leg detected by the leg state detection unit 2 and the result of the prediction that he/she will turn to the swing-leg direction.

Further, based on the information about the rotation of the chest around the pitch axis, the yaw axis, and the roll axis detected by the chest rotation detection unit 3, the direction prediction unit 4 predicts that the person will perform a step turn when it has determined that his/her spinal column is in a flexed state and his/her chest has rotated and side-flexed in the same direction as the traveling direction, and thereby predicts that the person will turn to the stance-leg direction. Then, the direction prediction unit 4 predicts the direction in which the person will turn based on the result of the prediction that he/she will turn to the stance-leg direction and the states of the left and right legs of the person detected by the leg state detection unit 2.

For example, the leg state detection unit 2 detects that the right leg is in a swing state and the left leg is in a stance state. Further, the direction prediction unit 4 predicts that the person will turn to the stance-leg direction based on the information about the rotation of the chest around the pitch axis, the yaw axis, and the roll axis detected by the chest rotation detection unit 3. In this case, the direction prediction unit 4 predicts that the person will turn to the left based on the result of the detection of the stance state of the left leg detected by the leg state detection unit 2 and the result of the prediction that he/she will turn to the stance-leg direction.

As described above, the turning direction prediction system 1 according to this embodiment can predict a direction in which a person will turn (a right turn or a left turn) based on information about the rotation of the chest of the person around the pitch axis, the yaw axis, and the roll axis, and the states of the left and right legs of the person.

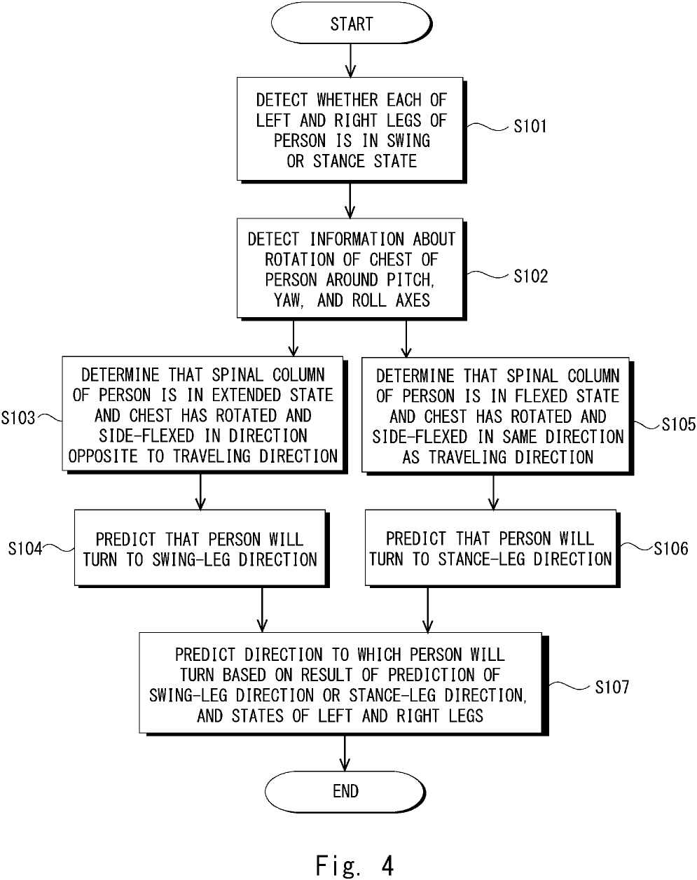

Next, a method for predicting a turning direction according to this embodiment will be described. FIG. 4 is a flowchart showing a flow of a method for predicting a turning direction according to this embodiment. Note that the processing flow shown in FIG. 4 may be repeatedly performed at predetermined intervals.

The leg state detection unit 2 detects whether each of the left and right legs of a person is in a swing state or a stance state, and outputs the result of the detection to the direction prediction unit 4 (Step S101).

The chest rotation detection unit 3 detects (i.e., acquires) information about the rotation of the chest of the person around the pitch axis, the yaw axis, and the roll axis, and outputs the result of the detection to the direction prediction unit 4 (Step S102).

Based on the information about the rotation of the chest around the pitch axis, the yaw axis, and the roll axis detected by the chest rotation detection unit 3, when the direction prediction unit 4 has detected that the spinal column of the person is in an extended state and his/her chest has been side-flexed in the direction opposite to the traveling direction (Step S103), the direction prediction unit 4 predicts that the person will turn to the swing-leg direction (Step S104).

Based on the information about the rotation of the chest around the pitch axis, the yaw axis, and the roll axis detected by the chest rotation detection unit 3, when the direction prediction unit 4 has detected that the spinal column of the person is in a flexed state and his/her chest has been side-flexed in the same direction as the traveling direction (Step S105), the direction prediction unit 4 predicts that the person will turn to the stance-leg direction (Step S106).

The direction prediction unit 4 predicts the direction in which the person will turn based on the result of the prediction that the person will turn to the swing-leg direction or the stance-leg direction, and the states of the left and right legs of the person detected by the leg state detection unit 2 (Step S107).

Note that although the process in (Step S101) is performed at the beginning of the above-described series of processes, it is not limited to this example. For example, the process in (Step S101) may be performed after (Step 102) to (Step S106) or may be performed simultaneously with them. That is, the process in (Step S101) may be performed at any timing as long as it is performed before (Step S107).

As described above, the turning direction prediction system 1 according to this embodiment includes the leg state detection unit 2 that detects whether each of left and right legs of a person is in a swing state or a stance state, the chest rotation detection unit 3 that detects (i.e., acquires) information about the rotation of the chest of the person around the pitch axis, the yaw axis, and the roll axis, and the direction prediction unit 4 that predicts a direction in which the person will turn based on the states of the left and right legs detected by the leg state detection unit 2 and the information about the rotation of the chest detected by the chest rotation detection unit 3.

According to the turning direction prediction system 1 in accordance with this embodiment, it is possible to accurately and swiftly predict the direction in which a person will turn by recognizing that he/she intends to make a turn by using human biomechanics.

### Second Embodiment

For example, people tend to perform a preliminary motion of turning their heads to the direction in which they are going to turn. In this embodiment, the direction prediction unit 4 predicts a direction in which a person will turn more accurately by detecting a preliminary motion relevant to his/her neck in addition to the preliminary motion described in the above-described embodiment.

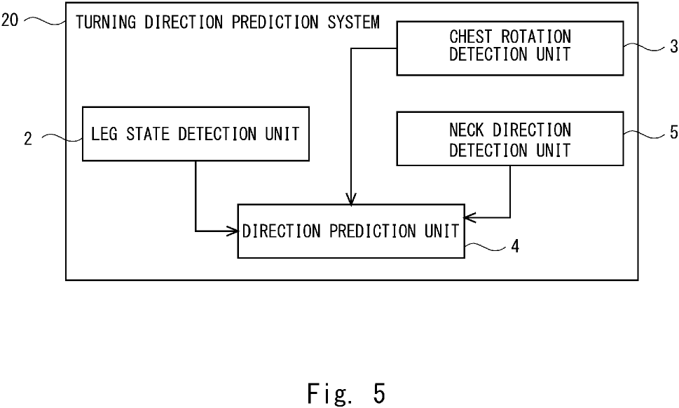

FIG. 5 is a block diagram showing a rough system configuration of a turning direction prediction system according to this embodiment. Note that, in this embodiment, the same reference numerals (or symbols) are assigned to the same components as those in the above-described embodiment, and detailed descriptions thereof are omitted. In addition to the configuration of the above-described first embodiment, a turning direction prediction system 20 according to this embodiment further includes a neck direction detection unit 5 that detects the direction of the rotation of the neck of a person around the yaw axis.

The neck direction detection unit 5 is a specific example of a neck direction detection means. The neck direction detection unit 5 detects the direction of the rotation of the neck of the person around the yaw axis based on, for example, an image(s) of the person acquired by a 3D camera.

The direction prediction unit 4 predicts a tentative direction in which the person will turn based on the states of the left and right legs detected by the leg state detection unit 2 and the information about the rotation of the chest detected by the chest rotation detection unit 3. Further, when the direction prediction unit 4 determines that the predicted tentative direction coincides with the direction of the rotation of the neck detected by the neck direction detection unit 5, the direction prediction unit 4 predicts (i.e., determines) the tentative direction as the direction in which the person will turn.

As described above, it is possible to predict a direction in which a person will turn more accurately by detecting a preliminary motion relevant to his/her neck in addition to the preliminary motion related to his/her chest (spinal column).

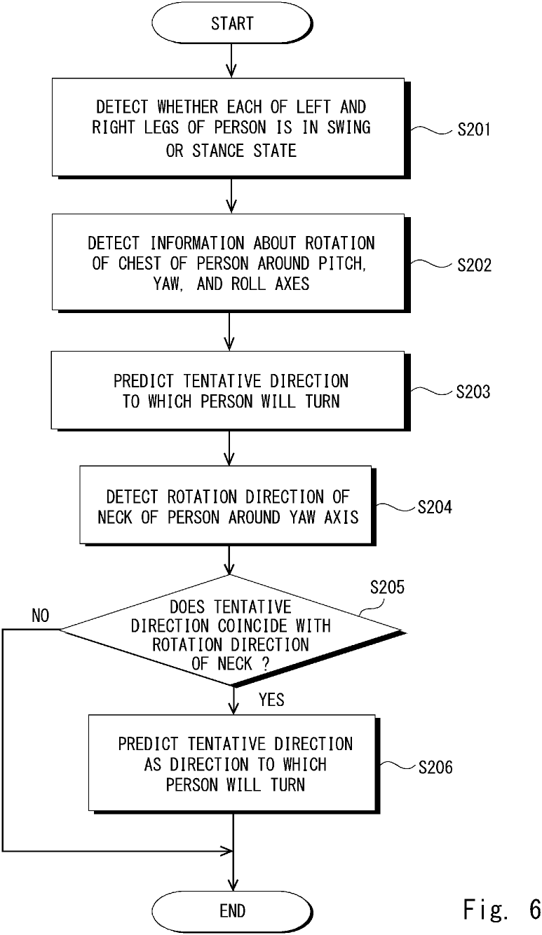

FIG. 6 is a flowchart showing a flow of a method for predicting a turning direction according to this embodiment. Note that the processing flow shown in FIG. 6 may be repeatedly performed at predetermined intervals. The leg state detection unit 2 detects whether each of the left and right legs of the person is in a swing state or a stance state, and outputs the result of the detection to the direction prediction unit 4 (Step S201).

The chest rotation detection unit 3 detects (i.e., acquires) information about the rotation of the chest of the person around the pitch axis, the yaw axis, and the roll axis, and outputs the result of the detection to the direction prediction unit 4 (Step S202).

The direction prediction unit 4 predicts a tentative direction in which the person will turn based on the states of the left and right legs detected by the leg state detection unit 2 and the information about the rotation of the chest detected by the chest rotation detection unit 3 (Step S203).

The neck direction detection unit 5 detects the direction of the rotation of the neck of the person around the yaw axis based on an image(s) of the person acquired by the 3D camera (Step S204).

The direction prediction unit 4 detects (i.e., determines) whether or not the predicted tentative direction coincides with the direction of the rotation of the neck detected by the neck direction detection unit 5 (Step S205).

When the direction prediction unit 4 detects (i.e., determines) that the predicted tentative direction coincides with the direction of the rotation of the neck (Yes at Step S205), it predicts (i.e., determines) the tentative direction as the direction in which the person will turn (Step S206).

Note that the process in (Step S204) may be performed after (Step 201) to (Step S203) or may be performed simultaneously with them. That is, the process in (Step S204) may be performed at any timing as long as it is performed before (Step S205).

### Third Embodiment

For example, people tend to perform a preliminary motion of turning their eyes (the line of sight) to the direction in which they are going to turn. In this embodiment, the direction prediction unit 4 predicts a direction in which a person will turn more accurately by detecting a preliminary motion relevant to his/her eyes in addition to the preliminary motion described in the above-described embodiment.

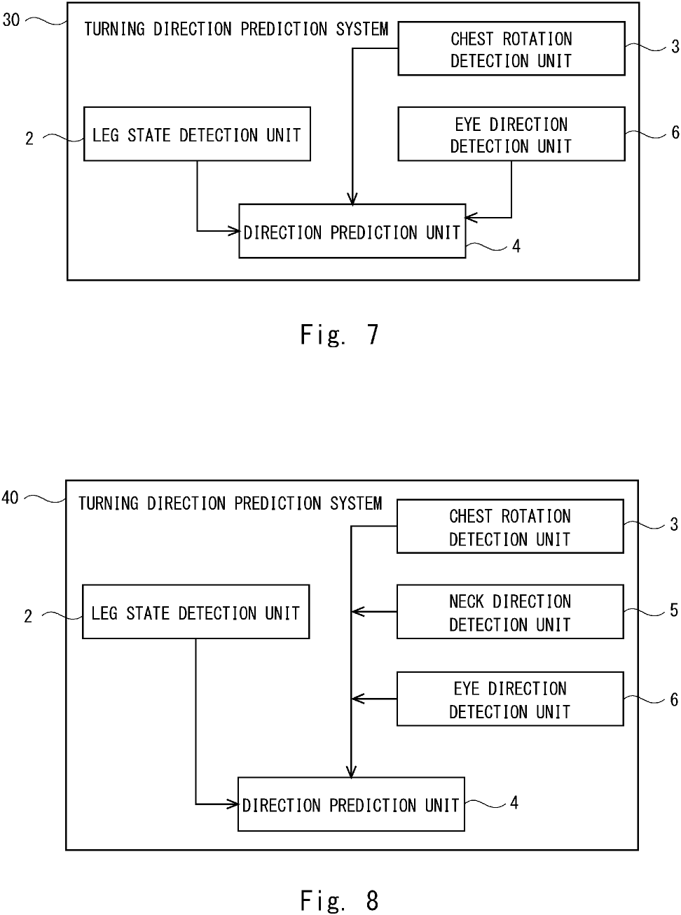

FIG. 7 is a block diagram showing a rough system configuration of a turning direction prediction system according to this embodiment. Note that, in this embodiment, the same reference numerals (or symbols) are assigned to the same components as those in the above-described embodiment, and detailed descriptions thereof are omitted.

In addition to the configuration of the above-described first embodiment, a turning direction prediction system 30 according to this embodiment further includes an eye direction detection unit 6 that detects the eye direction of a person. The eye direction detection unit 6 is a specific example of an eye direction detection means. The eye direction detection unit 6 detects the eye direction (the line of sight) of the person based on, for example, an image(s) of the person acquired by a 3D camera.

The direction prediction unit 4 predicts a tentative direction in which the person will turn based on the states of the left and right legs detected by the leg state detection unit 2 and the information about the rotation of the chest detected by the chest rotation detection unit 3. Further, when the direction prediction unit 4 determines that the predicted tentative direction coincides with the eye direction detected by the eye direction detection unit 6, the direction prediction unit 4 predicts (i.e., determines) the tentative direction as the direction in which the person will turn.

As described above, it is possible to predict a direction in which a person will turn more accurately by detecting a preliminary motion relevant to his/her eyes in addition to the preliminary motion relevant to his/her chest (spinal column).

### Fourth Embodiment

In this embodiment, a direction in which a person will turn is predicted more accurately by detecting a preliminary motion relevant to his/her chest (spinal column), a preliminary motion relevant to his/her neck, and a preliminary motion performed by his/her eyes.

FIG. 8 is a block diagram showing a rough system configuration of a turning direction prediction system according to this embodiment. Note that, in this embodiment, the same reference numerals (or symbols) are assigned to the same components as those in the above-described embodiment, and detailed descriptions thereof are omitted.

In addition to the configuration of the above-described first embodiment, a turning direction prediction system 40 according to this embodiment further includes a neck direction detection unit 5 that detects the direction of the rotation of the neck of a person around the yaw axis and an eye direction detection unit 6 that detects the direction of his/her eyes.

The direction prediction unit 4 predicts a direction in which a person will turn based on the states of the legs detected by the leg state detection unit 2, the information about the rotation of the chest detected by the chest rotation detection unit 3, the direction of the rotation of the neck detected by the neck direction detection unit 5, and the eye direction detected by the eye direction detection unit 6.

In this way, it is possible to predict a direction in which a person will turn more accurately by detecting a preliminary motion relevant to his/her chest (spinal column), a preliminary motion relevant to his/her neck, and a preliminary motion performed by his/her eyes.

It should be noted that when a person will turn, he/she tends to perform such preliminary motions that he/she first turns his/her gaze to the direction in which he/she is going to turn (i.e., to the traveling direction), then turns his/her head (neck) to that direction, and lastly turns his/her chest to that direction. Therefore, it is considered that when such a series of preliminary motions are performed in the same direction, there is a higher probability that the person will turn to the tentative direction predicted based on the information about the rotation of the chest.

In consideration of the above-described fact, in this embodiment, the direction prediction unit 4 predicts a tentative direction in which a person will turn based on the states of the left and right legs detected by the leg state detection unit 2 and the information about the rotation of the chest detected by the chest rotation detection unit 3. Then, when the direction prediction unit 4 determines that the eye direction, the direction of the rotation of the neck around the yaw axis, and the direction of the rotation of the chest around the yaw axis have successively pointed to the same direction in this order, the direction prediction unit 4 predicts (i.e., determines) the tentative direction as the direction in which the person will turn.

In this way, by recognizing the preliminary motion relevant to the chest (the spinal column) of the person, the preliminary motion relevant to his/her neck, and the preliminary motion performed by his/her eyes as a series of preliminary motions, it is possible to predict the direction in which the person will turn more accurately.

### Fifth Embodiment

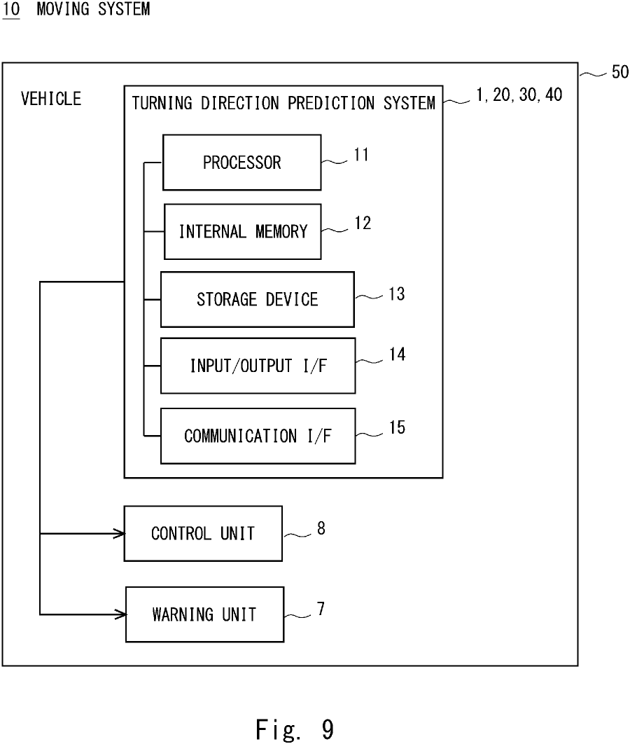

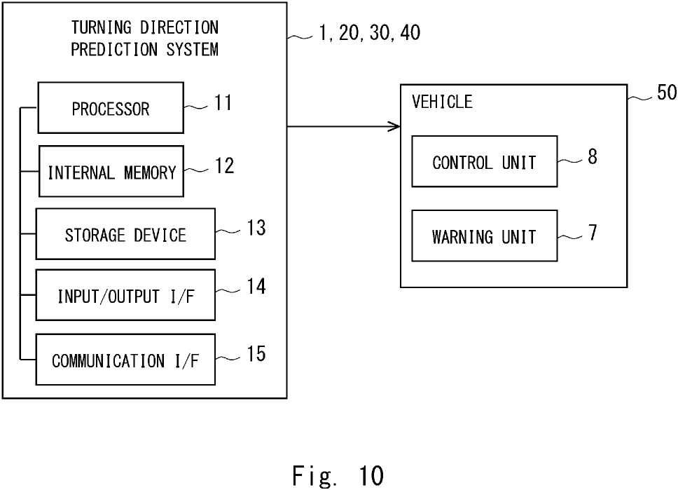

In a moving system according to this embodiment, at least one of the turning direction prediction systems 1, 20, 30 and 40 according to the above-described embodiments is installed in a vehicle. FIG. 9 shows a rough system configuration of a moving system according to this embodiment. Note that, in this embodiment, the same reference numerals (or symbols) are assigned to the same components as those in the above-described embodiment, and detailed descriptions thereof are omitted. A vehicle 50 according to this embodiment is configured, for example, as an autonomous mobile robot that autonomously moves by driving a wheel(s).

A moving system 10 includes at least one of the turning direction prediction systems 1, 20, 30 and 40 according to the above-described embodiments, a warning unit 7 that warns a person, and a control unit 8 that controls the movement of the vehicle 50.

Each of the turning direction prediction system 1, 20, 30 and 40 has a hardware configuration of an ordinary computer including, for example, a processor 11 such as a CPU (Central Processing Unit) or a GPU (Graphics Processing Unit), an internal memory 12 such as a RAM (Random Access Memory) or a ROM (Read Only Memory), a storage device 13 such as an HDD (Hard Disk Drive) or an SSD (Solid State Drive), an input/output I/F 14 for connecting peripheral devices such as a display, and a communication I/F 15 for communicating with apparatuses located outside the turning direction prediction apparatus.

The warning unit 7 is a specific example of a warning means. The warning unit 7 warns a user, for example, by outputting a sound and/or light.

When the warning unit 7 determines that, for example, a person and the vehicle 50 will collide into each other based on the direction in which the person will turn predicted by the turning direction prediction system 1, 20, 30 or 40, the warning unit 7 warns the person. By this warning, for example, the person can recognize the approach of the vehicle 50, and thereby avoid the collision between the person and the vehicle 50.

The control unit 8 is a specific example of a control means When the control unit 8 determines that, for example, a person and the vehicle 50 will collide into each other based on the direction in which the person will turn predicted by the turning direction prediction system 1, 20, 30 or 40, the control unit 8 controls the vehicle 50 so that the vehicle 50 evades the person. The control unit 8 performs, for example, deceleration control and/or steering control of the vehicle 50 so that the vehicle 50 evades the person. In this way, it is possible to prevent the person and the vehicle 50 from colliding into each other.

Note that, in this embodiment, the vehicle 50 may include only one of the warning unit 7 and the control unit 8. Further, at least one of the warning unit 7 and the control unit 8 may be provided outside the vehicle 50.

Further, although at least one of the turning direction prediction systems 1, 20, 30 and 40 is installed in the vehicle 50 in this embodiment, it is not limited to this example. For example, at least one of the turning direction prediction systems 1, 20, 30 and 40 may be provided outside the vehicle 50 as shown in FIG. 10.

The turning direction prediction system 1, 20, 30 or 40 transmits information about the predicted direction in which a person will turn to the vehicle 50 through radio communication or the like. The warning unit 7 of the vehicle 50 warns a user based on the information about the direction in which the person will turn transmitted from the turning direction prediction system 1, 20, 30 or 40. The control unit 8 of the vehicle 50 controls the vehicle 50 based on the information about the direction in which the person will turn transmitted from the turning direction prediction system 1, 20, 30 or 40 so that the vehicle 50 evades the person.

Several embodiments according to the present disclosure have been described above. However, these embodiments are shown as examples but are not shown to limit the scope of the disclosure. These novel embodiments can be implemented in various forms. Further, their components/structures may be omitted, replaced, or modified without departing from the scope of the disclosure. These embodiments and their modifications are included in the scope of the disclosure, and included in the scope equivalent to the present disclosure specified in the claims.

The present disclosure can also be implemented, for example, by carrying out the processes shown in FIGS. 4 or 6 by having a processor execute a computer program(s).

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Read Only Memory), CD-R, CD-R/W, and semiconductor memories (such as mask ROM, PROM (Programmable ROM), EPROM (Erasable PROM), flash ROM, and RAM (Random Access Memory)).

The program may be provided to a computer using any type of transitory computer readable media. Examples of transitory computer readable media include electric signals, optical signals, and electromagnetic waves. Transitory computer readable media can provide the program to a computer through a wired communication line (e.g., electric wires, and optical fibers) or a wireless communication line.

Each of the components constituting each of the turning direction prediction systems 1, 20, 30 and 40 according to the above-described embodiments is, in addition to being able to be implemented by the program, able to be partially or entirely implemented by dedicated hardware such as an ASIC (Application Specific Integrated Circuit) or an FPGA (Field-Programmable Gate Array).

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A turning direction prediction system comprising:
a processor having a leg state detection unit, a chest rotation detection unit, and a direction prediction unit,
the leg state detection unit configured to detect whether each of left and right legs of a person is in a swing state or a stance state;
the chest rotation detection unit configured to detect information about a rotation of a chest of the person around a pitch axis, a yaw axis, and a roll axis; and
the direction prediction unit configured to predict a direction in which the person will turn based on the states of the left and right legs detected by the leg state detection unit and the information about the rotation of the chest detected by the chest rotation detection unit.

2. The turning direction prediction system according to claim 1, wherein
the direction prediction unit is configured to predict the person will turn to a swing-leg direction when it has determined that a spinal column of the person is in an extended state and the chest has rotated and side-flexed in a direction opposite to a traveling direction based on the information about the rotation of the chest around the pitch axis, the yaw axis, and the roll axis detected by the chest rotation detection unit, and
the direction prediction unit is configured to predict the direction in which the person will turn based on a result of the prediction that the person will turn to the swing-leg direction and the states of the left and right legs of the person detected by the leg state detection unit.

3. The turning direction prediction system according to claim 1, wherein
the direction prediction unit is configured to predict the person will turn to a stance-leg direction when it has determined that a spinal column of the person is in a flexed state and the chest has rotated and side-flexed in the same direction as the traveling direction based on the information about the rotation of the chest around the pitch axis, the yaw axis, and the roll axis detected by the chest rotation detection unit, and
the direction prediction unit is configured to predict the direction in which the person will turn based on a result of the prediction that the person will turn to the stance-leg direction and the states of the left and right legs of the person detected by the leg state detection unit.

4. The turning direction prediction system according to claim 1, wherein the processor includes a neck direction detection unit, the neck direction unit is configured to detect a direction of a rotation of a neck of the person around the yaw axis, wherein
the direction prediction unit is configured to predict a tentative direction in which the person will turn based on the states of the left and right legs detected by the leg state detection unit and the information about the rotation of the chest detected by the chest rotation detection unit, and
the direction prediction unit is configured to predict the predicted tentative direction as the direction in which the person will turn when it has determined that the predicted tentative direction coincides with the direction of the rotation of the neck around the yaw axis detected by the neck direction detection unit.

5. The turning direction prediction system according to claim 4, wherein the processor includes an eye direction detection unit, the eye direction detection unit is configured to detect an eye direction of the person, wherein
the direction prediction unit is configured to predict a tentative direction in which the person will turn based on the states of the left and right legs detected by the leg state detection unit and the information about the rotation of the chest detected by the chest rotation detection unit, and
the direction prediction unit is configured to predict the predicted tentative direction as the direction in which the person will turn when it has determined that the predicted tentative direction coincides with the eye direction detected by the eye direction detection unit.

6. The turning direction prediction system according to claim 5, wherein the direction prediction unit is configured to predict the direction in which the person will turn based on the states of the left and right legs detected by the leg state detection unit, the information about the rotation of the chest detected by the chest rotation detection unit, the direction of the rotation of the neck detected by the neck direction detection unit, and the eye direction detected by the eye direction detection unit.

7. The turning direction prediction system according to claim 6, wherein
the direction prediction unit is configured to predict a tentative direction in which the person will turn based on the states of the left and right legs detected by the leg state detection unit and the information about the rotation of the chest detected by the chest rotation detection unit, and
the direction prediction unit is configured to predict the tentative direction as the direction in which the person will turn when it has determined that all the eye direction, the direction of the rotation of the neck around the yaw axis, and the direction of the rotation of the chest around the yaw axis have successively pointed to the same direction in this order.

8. A moving system comprising:
the turning direction prediction system according to claim 1; and
warning unit configured to warn the person based on the direction in which the person will turn predicted by the direction prediction unit.

9. A moving system comprising:
the turning direction prediction system according to claim 1; and
control unit configured to control, based on the direction in which the person will turn predicted by the direction prediction unit, a vehicle so that the vehicle evades the person.

10. A turning direction prediction method comprising:
detecting whether each of left and right legs of a person is in a swing state or a stance state;
detecting information about a rotation of a chest of the person around a pitch axis, a yaw axis, and a roll axis; and
predicting a direction in which the person will turn based on the detected states of the left and right legs and the detected information about the rotation of the chest.

11. A non-transitory computer readable medium storing a program for causing a computer to perform:
a process for detecting whether each of left and right legs of a person is in a swing state or a stance state;
a process for detecting information about a rotation of a chest of the person around a pitch axis, a yaw axis, and a roll axis; and
a process for predicting a direction in which the person will turn based on the detected states of the left and right legs and the detected information about the rotation of the chest.
